(19) United States
(12) Patent Application Publication
(10) Pub. No.: US 2009/0159419 A1
(43) Pub. Date: Jun. 25, 2009

(54) SOLVENT RECYCLER

(75) Inventors: Dennis Mount, Ottawa (CA); Justin Johnston, Ottawa (CA)

Correspondence Address: TODD S. PARKHURST;HUGHES SOCOL PIERS RESNICK & DYM LTD., THREE FIRST NATIONAL PLAZA, 70 WEST MADISON- SUITE 4000, CHICAGO, IL, 60602, US

(73) Assignee: ChemChamp LLC, Ottawa (CA)

(21) Appl. No.: 12/268,161

(22) Filed: Nov. 10, 2008

Related U.S. Application Data
(60) Provisional application No. 60/986,834, filed on Nov. 9, 2007.

(51) Int. Cl. B01D 3/00

(52) U.S. Cl. 202/164

(57) ABSTRACT

In a solvent recycling system, a distillation vessel having an upper distillation zone and a lower waste collection zone and means whereby solvent waste falls into said waste collection zone before solvent enters said distillation zone. The system preferably has a solvent vapour outlet and a heating means, whereby solvent enters the vessel from above through the solvent feed inlet and solvent waste falls into said waste collection zone before distillation is commenced, and a shut-off means or filling tube extending below the distillation zone associated with the inlet to prevent solvent vapours exiting the vessel through the inlet during distillation.

This application claims priority from U.S. provisional application Ser. No. 60/986,834 filed Nov. 9, 2007.

### FIELD OF THE INVENTION

The system relates to a solvent recycler for use in any application wherein fluid is desired to be recycled or separated from contaminants.

### BACKGROUND OF THE INVENTION

Waste solvent generated by an end user is traditionally collected in a waste drum at the point of source. Upon the waste drum becoming full, a waste hauler is contracted to pick up the waste drum for a fee, to facilitate proper disposal. The end customer then purchases new solvent to continue the cleaning operations. Thus, the customer is paying to have contaminated solvent removed that likely contains a relatively small amount of contaminants but is still dirty enough to prohibit re-use. The customer is therefore paying to have the total volume removed plus paying all over again for new solvent. This process is expensive for the end user and is becoming more and more cost prohibitive as the cost of transportation and solvents continue to rise.

The foregoing problem has led to the emergence of solvent recycling equipment for use on-site at the customer's facility and various recycling systems for this purpose may be found in paint shops and/or fluid-use establishments. As an example, reference is made to our published PCT application no. WO01/03810, the contents of which are incorporated herein by reference. In general, these units are batch distillation units. The end user purchases or rents a unit from a distributor or waste hauler. Typically, the operation of the unit requires the user to collect the contaminated waste in a container, for example, a five gallon can. Once five gallons are available in the can, the user opens the cover of the distillation unit, installs a solid waste collection bag in the distillation chamber, then pours the five gallons of used solvent into the bag and closes the cover. The distillation process is then started and the operator must wait a number of hours for the process to be complete and the user must provide a separate clean container to collect the clean solvent for re-use. During this time the user may have produced another batch of used solvent but must wait for the unit to cool down before being able to open the cover of the distillation unit to introduce the next batch. After opening the cover and before running the next batch, the operator must remove the bag which has collected the solvent waste in the form of sludge from the previous batch and must place it into a separate drum for collection and removal. The bag is replaced by a new bag and the process is run again.

The foregoing has a number of disadvantages, some of which may be enumerated as follows:

a) High capital cost of the equipment, thus limiting greatly market acceptance.
b) The necessity for training end users on proper use of the system.
c) Added cost of labor time the end user must spend in order to use the equipment.
d) The system is required to have separate containers for used solvent collection, clean solvent collection and sludge collection.
e) The units take up a lot of space, which is exacerbated by the need for separate containers. Also, due to size, the units are expensive to ship, thus increasing the cost of a new unit and of shipping for repair.
f) Before adding more used solvent, the user must wait for a batch to be complete and the unit to cool down, therefore greatly limiting how much the unit can process as the cool down and warm up time is lost.
g) The processing speed of the unit is relatively slow and its processing ability is based upon the size of the distillation chamber. Therefore in order to increase capacity, the distillation chamber size must be increased, which is very costly and requires the manufacturer to inventory many models to cover the different processing volume requirements various customers may have.
h) The units are power-inefficient, as the complete volume including contaminant/sludge of the batch to be recycled must be heated.
i) The distillation vessel is filled manually by the user, who is therefore responsible for ensuring it is not overfilled. If the vessel is overfilled, the volume expands upon heating and contaminated solvent can enter the clean vapor outlet and into the cooling system, thus resulting in the clean solvent being dirty.
j) The cover of the distillation vessel has a gasket for sealing. If the cover is opened when the unit is still warm, the gasket will expand and pop out, thus preventing the cover from being closed and consequently releasing potential harmful vapors to the work place.
k) The requirement for a contaminant/sludge collection bag has a number of attendant disadvantages, including extra cost, diminished capacity of the distillation vessel and the necessity for expensive removal by the waste hauler. The use of a bag can be hazardous due to pressure build up unless some kind of anti-pressure system is provided, such as that described in our U.S. application Ser. No. 10/363,242, the contents of which are incorporated herein by reference. If the bag is not changed before each batch is processed, sludge from the previous batch will insulate the solvent from being heated properly, therefore inhibiting the process. If the operator, upon pouring used solvent into the bag overfills or splashes it, resulting in some used solvent collecting behind the bag, the result can be a mess for the user to clean up as the used solvent behind the bag during the distillation process may turn to a sticky sludge, causing the bag to stick to the distillation vessel walls making it very difficult to remove. Upon the bag being removed, cleaning the sludge from the bottom of the vessel is difficult at best and can be reason enough for a customer to stop using the unit. Also, bags sometimes break resulting in major clean up.

Recycling units are available which offer automatic filling of the distillation chamber. Normally, this option is used in larger volume applications. These units may not use bags and can be equipped with means whereby the distillation chamber senses when the level in the distillation chamber has lowered and automatically pumps used solvent from a collection container as the distillation chamber level allows. Generally, these units are heated from the bottom of the distillation chamber, which means that the waste collection zone at the bottom of the chamber and the distillation zone are not separate and any sludge forming in the waste collection zone will build up and impede the efficient transfer of heat in the distillation zone. Therefore, the sludge must be removed on a regular basis. The unit will operate until a certain amount of sludge is accumulated, at which point the unit turns itself off, waits to cool down then indicates by a flashing light, for example, that the sludge must be emptied from the distillation chamber before processing can continue. The emptying of the sludge is done manually or automatically by opening a valve at the bottom of the distillation chamber and discharging it into a separate sludge container for removal. The operator normally needs to be present to ensure the sludge drum does not overfill. When dealing with a used solvent containing, for example, paint waste, the paint tends to stick to the walls of the distillation chamber which inhibits the processing efficiency of the unit. In order to address this, the current units offer a scraper option which typically comprises a scraper assembly rotating inside the distillation chamber, scraping the walls of the distillation chamber. Further problems with these units in addition to the foregoing are:

a) In order to fill the distillation chamber from a separate remote used solvent drum, the unit requires a pump and hosing which may fail and/or clog.
b) Filling of the distillation chamber is from the top, thus requiring the unit to process all of the sludge in the distillation or separation chamber.
c) The unit must operate with extra power to overcome as much as possible the insulation of heat transfer to the solvent due to sludge build up and/or collection in distillation chamber.
d) Distillation chamber processing is limited to sludge collection capacity. The distillation chamber must be of adequate size to be able to process used solvent and hold a proportionate amount of sludge, thus making the unit very costly.
e) The unit must cool down before the operator can safely drain sludge into separate sludge container and then re-heat the distillation chamber before being able to continue distillation, thus reducing overall available distillation time.

An object of the invention is to provide a recycler in which the foregoing problems are avoided or at least mitigated.

### SUMMARY OF THE INVENTION

According to the invention, there is provided in a solvent recycling system a distillation vessel having an upper distillation zone and a lower waste collection zone and means whereby the distillation zone is fed with solvent from below said distillation zone, so that most or some of contaminant/sludge from used/waste solvent falls into said waste collection zone before solvent enters said distillation zone.

According to a further aspect of the invention, there is provided in a solvent recycling system, a distillation vessel having an upper distillation zone and a lower waste collection zone and means whereby solvent enters the vessel/container from above and solvent waste falls into said waste collection zone before distillation is commenced. The heating means for the distillation process may be top down or bottom up or immersion or from the side or any heating means whereby heat which is applied to the distillation zone is maintained in the upper region of the vessel and the waste collection zone is maintained in the lower region. Preferably, the distillation vessel comprises a drum which contains fresh solvent or which is empty as normally supplied to a customer and which is provided with a cover having a solvent feed inlet, a solvent vapour outlet and a heating means. The solvent feed inlet has a shut-off means so that vapour cannot escape through the inlet during the distillation process or an inlet tube extending to below the distillation zone. The outlet may be connected to a cooling means in order to condense the vapour exiting the outlet and the clean solvent condensate may be collected in a separate container for re-use.

### BRIEF DESCRIPTION OF THE DRAWINGS

Embodiments of the present invention will now be described, by way of example only, with reference to the attached Figures, wherein:

FIG. 1-20 are schematic views of recyclers according to various embodiments of the invention; and

FIGS. 21-27 show various designs of immersion heaters for use in the invention.

### DESCRIPTION OF PREFERRED EMBODIMENTS

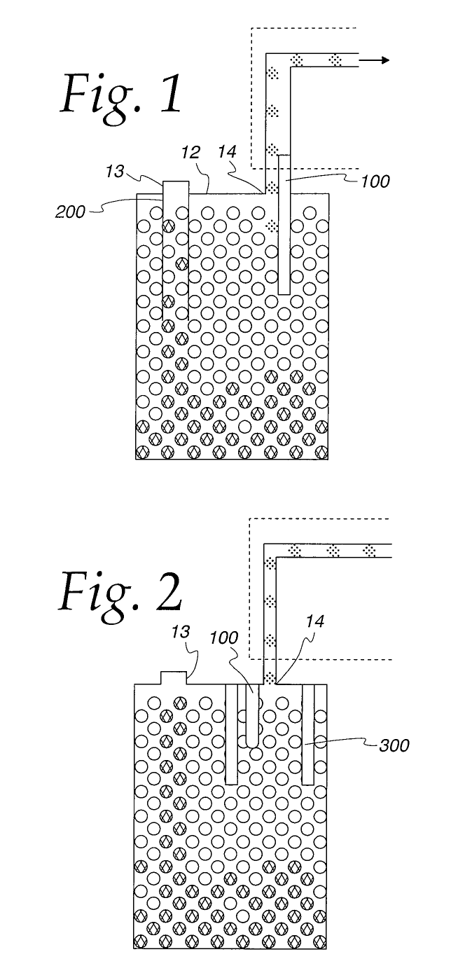

FIG. 1 shows schematically a waste drum 10 for solvent waste. The cover or top wall 12 of the waste drum 10 has an inlet 13 and an outlet 14. A heating means 100 extends downwardly into the drum 10. The upper region of the drum adjacent the heating means 100 defines a distillation zone and the lower region defines a waste collection zone. To prevent solvent vapors from the distillation zone within the drum 10 escaping through the inlet 13 of the drum, and to force the spent solvent entering the drum to enter the distillation zone from below, a tube 200 of inert material such as Teflon (it could be of any compatible material) extends downwardly from the inlet 13. In use, spent solvent from a washing operation is poured through the inlet 13 into the waste drum 10. The waste drum may be filled initially with clean solvent but eventually the waste drum will have only used solvent which has been introduced through the inlet. Heat is applied via the heating means 100, which may be in the form of an immersion heater having a jacketed heating element, to the solvent in the drum 10, to begin distilling off solvent vapors. The vapors pass through the outlet 14 and are condensed and collected. As the solvent flow exits the tube 200, the majority of the solid waste from the spent solvent separates out and falls as sludge to the bottom of the waste drum 10, which minimizes contamination of the distillation zone by the heavier contaminant or sludge or solid waste. Thus, it will be seen that the drum 10 has an upper distillation zone in the vicinity of the heating means and a lower waste collection zone and the drum acts as both the used/contaminated solvent supply drum and the contaminant/sludge/solid waste collection drum and the distillation zone, which may or may not be removable, eliminating the need for separate drums. Also in this scenario it is conceivable to be able to attach a heat source to any container with a vapor outlet thus turning the container into a three-in-one container being the distillation zone, waste collection container and contaminant/sludge container thus making for an extremely economical/versatile recycling system. Furthermore, there is no requirement for the use of a sludge collection bag, with all of the problems attendant upon the use of such bags as described above, since the solid waste falls by gravity to the waste collection zone of the drum 10 and away from the distillation zone surrounding the heating means 100. Recycling efficiency is maximized, since the waste solvent in the distillation zone is already free of most heavy contaminants which have dropped to the bottom of the drum, and which therefore cannot impede heat transfer from the heating means 100. Thus, when dealing with heavy solids or sticky waste, there is no need of costly scrapers or other means of sludge removal from the walls of the drum or from around the heating means.

FIG. 2 shows a similar arrangement to FIG. 1, except that instead of a tube 200 extending downwardly from inlet 13, there is a shroud 300 extending downwardly from the outlet 14. In the embodiment of FIG. 2, the shroud is wide enough to accommodate the heating means 100 but most importantly, the shroud surrounds the distillation zone, regardless of what form the heating means takes place. The shroud prevents solvent vapors from the distillation zone escaping through the inlet 13 of the drum, and it also forces the spent solvent entering the drum to enter the distillation zone from below.

It is especially advantageous that the heating is applied from the top down, rather than from the bottom up, as in many conventional recyclers. Although it is understood the heat could be from the bottom of the distillation zone provided the bottom remains open or may be opened periodically. The important point is that the distillation zone is always above the contaminant/sludge/solids collection zone. The benefit of the heat source being remote from the bottom of the distillation vessel is that the distillation zone is separate from the waste collection zone and therefore it is difficult for any sludge to accumulate on the heat source, thus ensuring the heating and recycling efficiency will not be impeded by sludge build up. Also, since only the distillation zone is being heated and not the entire drum or vessel, only the batch volume being recycled is heated, which makes the system highly efficient.

It will further be appreciated that waste solvent can never exit through the outlet 14 and contaminate the clean solvent vapour, since the outlet 14 is level with inlet 13.

A further advantage is that the entire volume of solvent above the bottom level of the distillation zone is available for recycling and the user does not have to wait for a “batch” to be complete or the unit to cool down before adding more. As the level drops in the collection drum while the recycling unit is in process, more solvent can be added through the inlet 13.

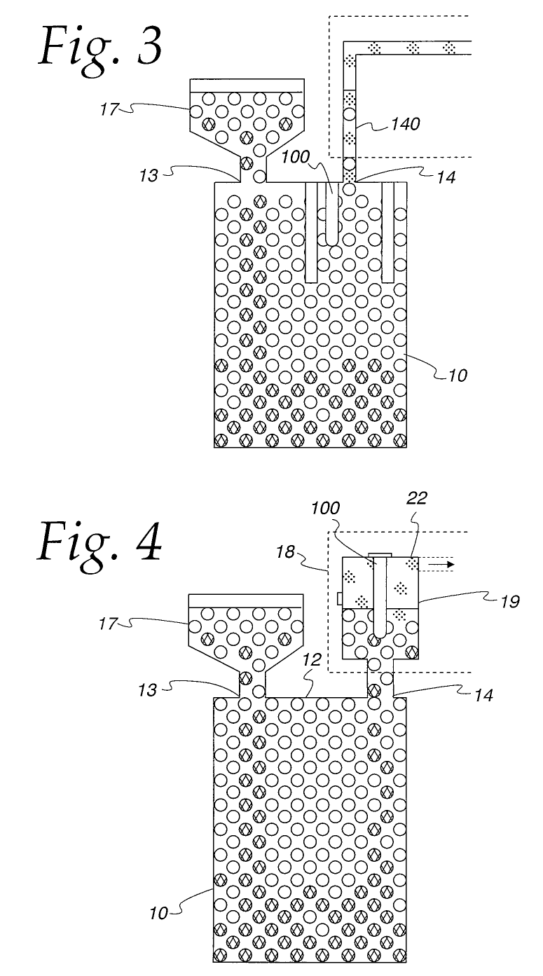

The embodiment of FIG. 3 is similar to FIGS. 1 and 2 and there is again a waste drum 10 for solvent waste with the cover or top wall 12 of the waste drum 10 having inlet 13 and outlet 14. FIG. 3 shows the arrangement of FIG. 2 with a shroud surrounding the distillation zone, but it could work equally well with the arrangement of FIG. 2 with a tube extending downwardly from the inlet 13. Outlet 14 has a vertical vapour exit conduit 140. In this embodiment, a funnel 17 is placed at the inlet 13 to the waste drum. In use, spent solvent is poured through the funnel into the waste drum 10. Again, the waste drum may be filled initially with clean solvent but eventually the waste drum will have only used solvent which has been introduced through the funnel. The solvent level rises until the funnel and consequently the outlet conduit 140 are filled to the desired level and heat is applied via the heating means 100 to begin distilling off solvent vapors. The height of the funnel is the maximum level that can be attained in the exit conduit 140. Therefore, since the conduit 140 extends above the maximum level of the funnel, it is impossible to overflow contaminated solvent into the clean solvent.

In the embodiment of FIG. 4, a separate distillation vessel is used. There is again a waste drum 10 for solvent waste, the cover or top wall 12 of which has inlet 13 and outlet 14. A funnel 17 is placed at the inlet 13 to the waste drum and a distillation vessel 19 of a recycler 18 is located at the outlet 14. The distillation vessel 19 is located over the waste drum outlet and in closed communication therewith. In this case, the heating means 100 extends downwardly into the distillation vessel 19. The bottom floor 24 of the distillation vessel is shown as flat but it may be sloped towards the exit 25 to facilitate waste removal. The top of the funnel 17 is arranged to be lower than the height of the vapour exit 22 from the distillation vessel 19. In use, spent solvent from a washing operation is again poured through the funnel into the waste drum 10. The solvent level rises until both the funnel and the distillation vessel are filled to the desired level and heat is applied to the distillation vessel to begin distilling off solvent vapors. Contaminants, Solid waste from the distillation process falls as sludge through the outlet 14 into the waste drum 10 and accumulates on the bottom of the waste drum. The height of the funnel is the maximum level that can be attained in the distillation vessel 19. Therefore, provided the vapour exit 22 is above maximum level of the funnel, it is impossible to overflow contaminated solvent into the vapour exit. Also the total volume to be recycled is controlled by the volume above the bottom of distillation zone and max level of the funnel. Therefore for example the distillation zone may be 1 gallon but will process the entire volume of the funnel which may be 5 gallons or 15 gallons depending on its width and length. Thus a one gallon novel recycler may process a 15 gallon batch. This has great economical advantages regarding the cost to build said novel recycler as compared to conventional recyclers which would require a 15 gallon distillation chamber to do the same. Also with the novel recycler system as soon as any amount has been recycled the level in funnel will drop allowing user to add more without need to open or disrupt recycling process.

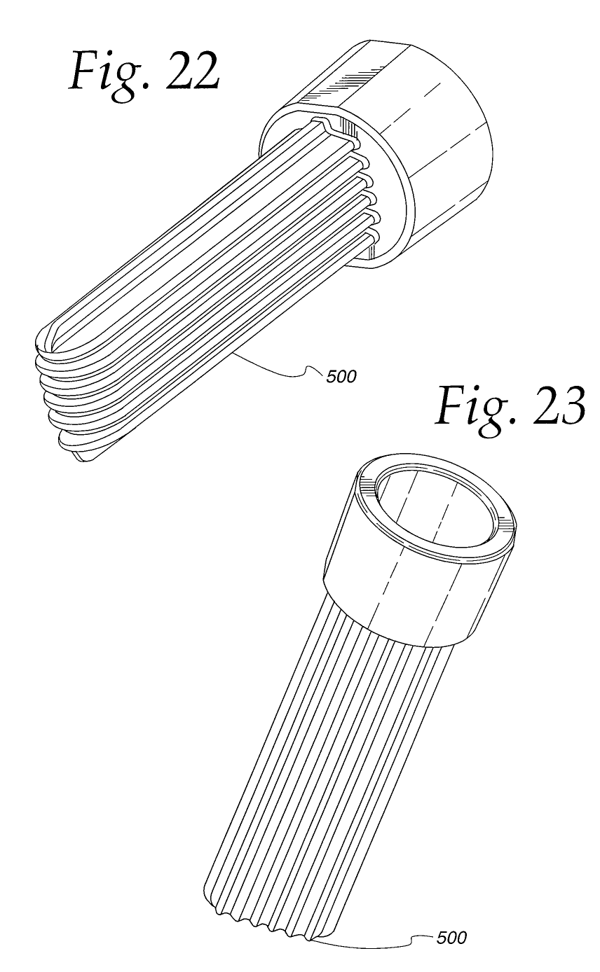

As an alternative to the immersion heater type of heating means illustrated in this embodiment, other heating means may be used, provided they are located remote from the waste collection zone. For example, microwave heating may be provided, surrounding the distillation zone of the chamber 19 or located above the chamber or other heating means located at top, side or bottom of distillation zone provided bottom is open all the time or periodically to the waste solvent/contaminant/sludge zone and provided recycling/distillation zone is above said waste solvent/contaminant/sludge collection zone/container Various forms of immersion heater are illustrated in FIGS. 22-27.

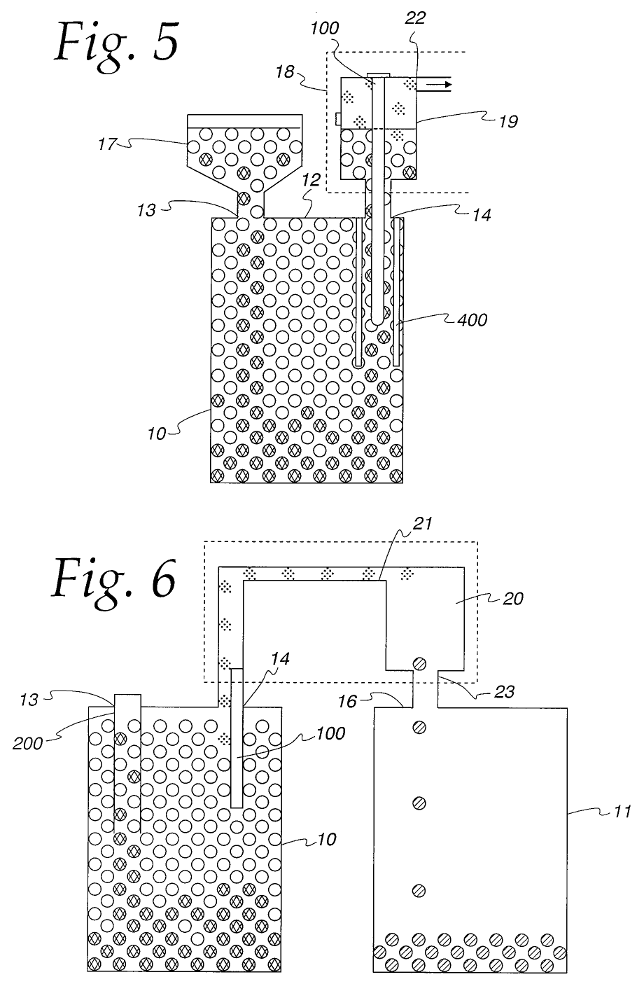

FIG. 5 shows the embodiment of FIG. 3 but with the heating means extended into the drum 10. This has the advantage of increasing the effective size of the distillation zone and hence the efficiency of the process. Again, to prevent solvent vapors from the distillation zone within the drum 10 escaping through the inlet 13 of the drum, a tube 400 of inert material such a Teflon or compatible material is provided around the portion of the heating element extending into the drum.

FIG. 6 shows a complete recycler based upon the embodiment of FIG. 1, the recycler again comprising waste drum 10 for solvent waste and additionally a clean drum 11 for clean solvent. The recycler includes a cooling system, such as a condenser 20. An inlet 21 to the condenser communicates with the outlet 14 of the drum and an outlet 23 of the condenser is located over an inlet 16 to the clean drum 11. If desired, the condenser 20 may be omitted and the solvent vapour allowed to condense in the conduit between the outlet 14 of the waste drum and the inlet 16 of the clean drum.

FIG. 7 shows a further embodiment of a complete recycler, this time based upon the embodiment of FIG. 4, including a funnel 17. As in FIG. 6, the recycler includes a cooling system, such as a condenser 20. An inlet 21 to the condenser communicates with the outlet 22 of the distillation vessel and an outlet 23 of the condenser is located over an inlet 16 to the clean drum 11. Again, if desired, the condenser 20 may be omitted and the solvent vapour allowed to condense in the conduit between the outlet 14 of the waste drum and the inlet 16 of the clean drum.

Conveniently, the system can be started with both the waste drum and the clean drum filled with clean solvent. The drums can be standard 55 gallon drums containing clean solvent as are commonly supplied to solvent use operations and the like. Clean solvent is withdrawn from the clean drum 11 for use in washing soiled parts and the used solvent from the cleaning operation is collected and poured through the funnel 17 into the waste drum 10 until the solvent level reaches a predetermined height in the funnel, which corresponds to the solvent level in the distillation vessel 19. Again, care is taken that the solvent level in the funnel and correspondingly in the distillation vessel does not rise above a predetermined height, to avoid over-filling the distillation vessel. Over-filling the distillation vessel results in the passage of used solvent out of the distillation vessel together with the clean solvent vapour, with consequent contamination of the solvent in clean drum 11. Once the selected solvent level in the funnel is reached, the heating elements or other heating means in the distillation vessel are energized and clean solvent vapors begin passing out of the distillation vessel and through the cooling system. The condensate in the form of clean liquid solvent is then passed into the clean drum 11 for further use. Thus, it can be seen that used solvent can be added to the system without stopping the recycling process. In other words, there is requirement to access the distillation vessel to add used solvent and hence there is no need to stop the process to allow the distillation vessel to cool down. Also, because the waste solvent is introduced into the recycler through the waste drum instead of being introduced directly into the recycler, concentrated dense waste solvent which forms solid waste (typically in the form of sludge) will fall to the bottom of the waste drum and can either be removed or the entire drum can simply be discarded and replaced by a fresh drum of clean solvent. In any event, the necessity for a sludge collection bag in the distillation vessel is eliminated.

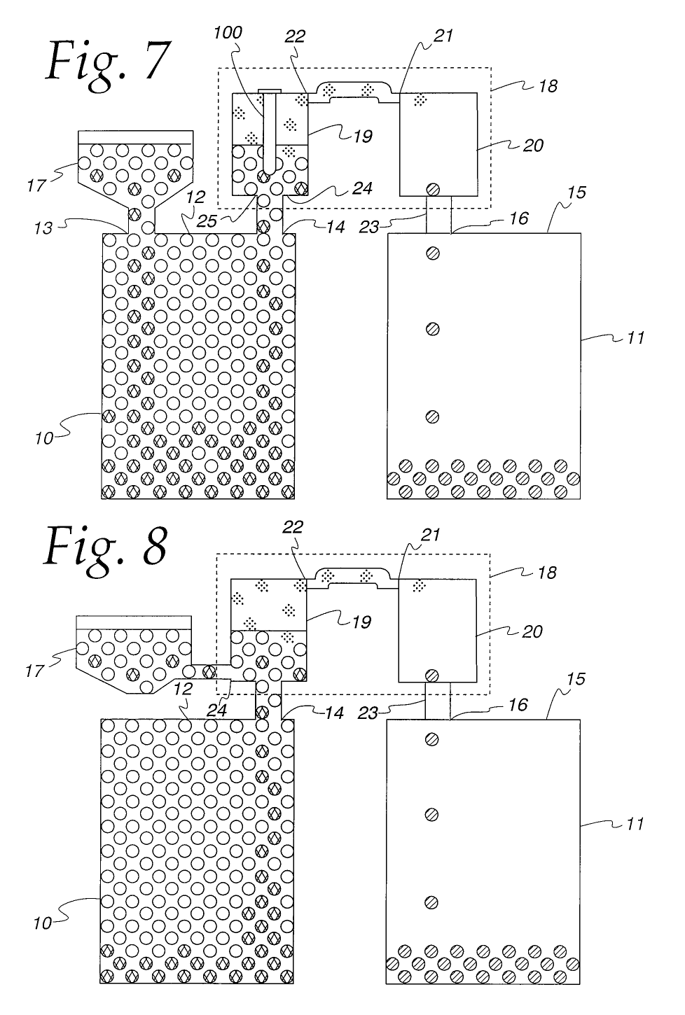

The level in the funnel can be monitored manually and the distillation unit turned on when the level is at the appropriate height or level sensing means such as a float switch or ultrasonic means may be provided to sense when the level is between permissible values and to turn the distillation unit on and off automatically. An ultrasonic sensor is particularly advantageous when dealing with waste solvent containing sticky heavier solids, since no mechanical device is in contact with the solvent. A mechanical float could become coated and therefore heavier, thus affecting its accuracy. A relatively small funnel may be provided for continuous feeding of used solvent to the system or a larger funnel may be provided for batch operation. Also, as illustrated in FIG. 8, it is possible for the funnel to feed the distillation vessel directly through an inlet 24, instead of feeding through the waste drum. The funnel may be replaced by a conduit, through which the used solvent is pumped into the waste drum. In that arrangement, the conduit can feed the distillation vessel through a filling tube which controls the solvent level, as described in co-pending provisional patent application Ser. No. 60/986,834, filed Nov. 9, 2007, entitled Solvent Recycler, respectively, the contents of which are incorporated herein by reference.

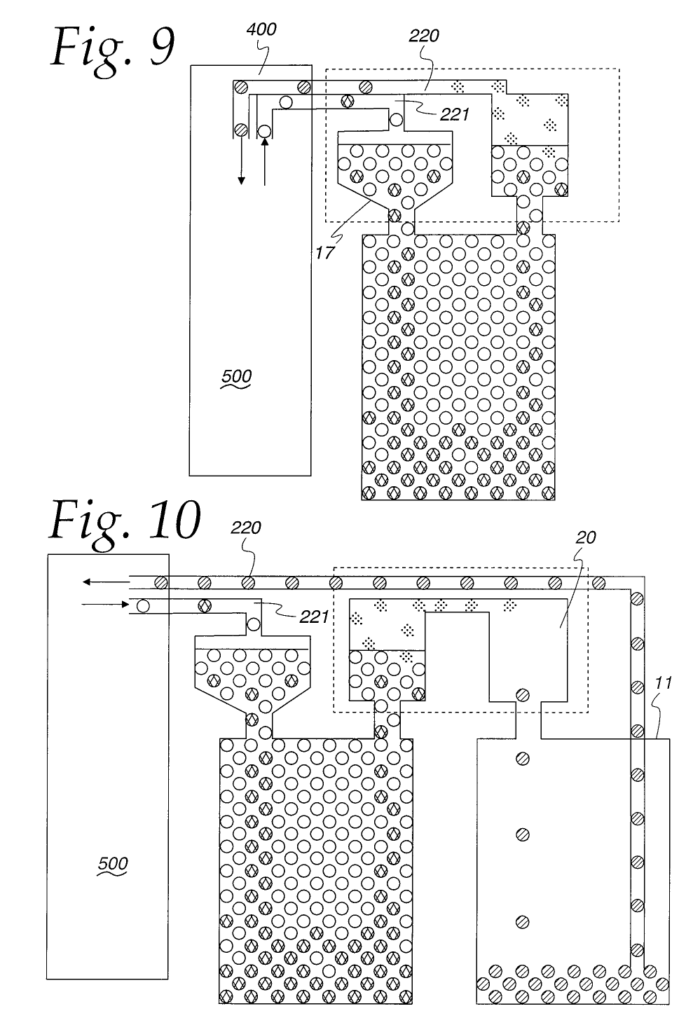

In the arrangement of FIG. 9, the solvent vapour is passed from the distillation vessel 19 through a conduit 220 and the condensed solvent passes to a process for example a gun washer GW as a clean solvent supply. Spent solvent is pumped directly to the funnel 17 through conduit 221. The arrangement of FIG. 10 is similar to FIG. 9 except that the vapour is passed firstly through a condenser 20 and into a clean drum 11, before the clean solvent is pumped to the gun washer GW. In the embodiments of FIGS. 9 and 10, it will be appreciated that the spent solvent can be pumped back to the funnel 17 from a waste drum which collects spent solvent from the gun washer.

In the embodiment of FIG. 11, the recycler 18 operates in the manner of that described in our U.S. application Ser. No. 10/363,242, the contents of which are incorporated herein by reference. In this case, the conduit 320 acts as a conduit and condensing means for solvent vapour to pass to the waste source/clean solvent supply 600 during the distillation phase and a feed conduit for used solvent to be sucked into the distillation vessel 19. A valve 400 is provided in the funnel which can be closed to provide a closed system while the distillation vessel is sucking used solvent from waste source 600 and opened to allow for heavy waste to be introduced to the drum 10 through the funnel. Thus, in this arrangement, the distillation chamber 18 can be fed from either the waste drum 10 or from the waste source 600. This provides an extremely flexible arrangement, which allows very heavy waste such as paint to be processed by feeding it through the drum 10 to the recycler and spent solvent to be fed through the conduit 320.

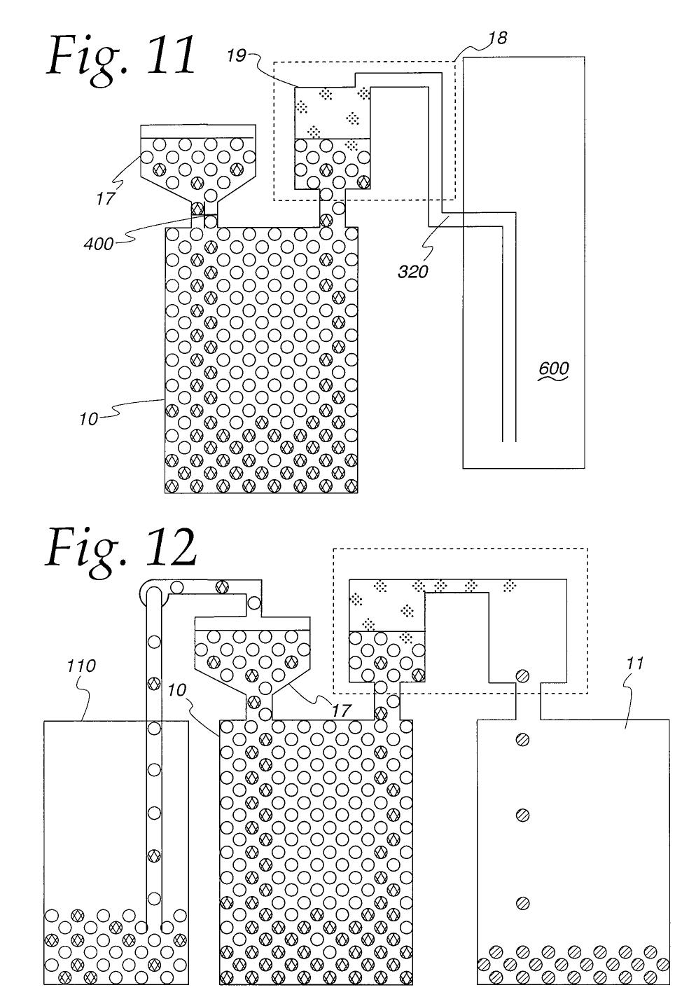

In the embodiment of FIG. 12, spent solvent is pumped into the drum 10 from a waste drum 110, through the funnel 17. This has the advantage that a relatively small standard drum (e.g. a 55 gallon drum) can be used as the drum 10 whilst the drum 110 can be much larger and can act as a large holding tank for spent solvent. The funnel is not necessary but is advantageous as a convenient means of sensing and controlling the level in the system so as to prevent over-filling.

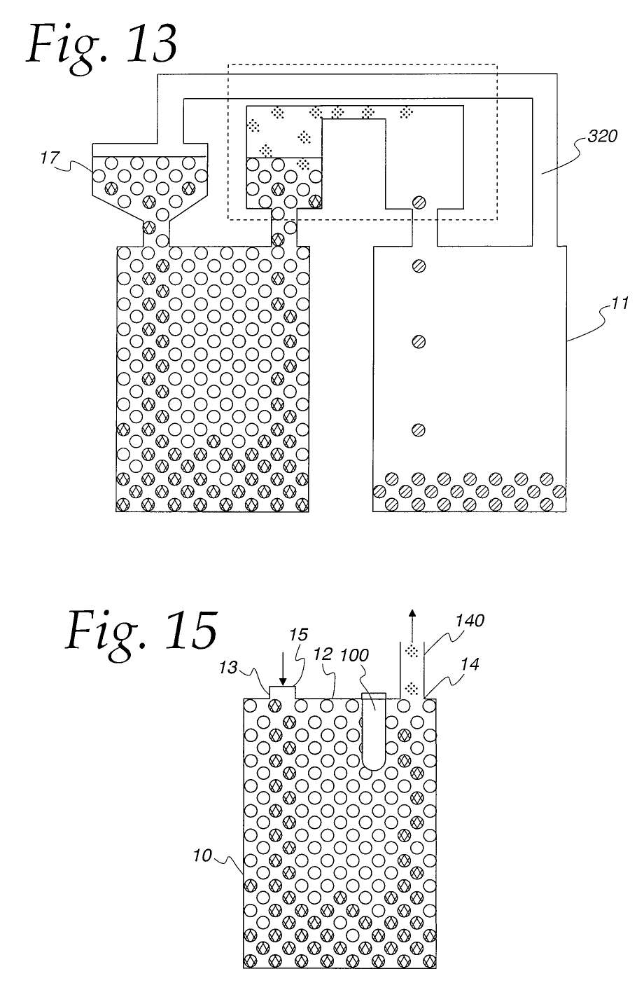

FIG. 13 shows a closed system, which is ecologically advantageous and in some jurisdictions may be necessary to meet environmental legislation. The system is similar to that of FIG. 7 except that a return conduit 320 for solvent vapour from the clean drum 11 is provided to pass such vapour to funnel 17 (which is also closed in this case) for further recycling through the system.

Conveniently, the distillation vessel and the condenser are placed inside a single housing in the manner of a “black box” which has an inlet conduit for the distillation vessel and an outlet conduit from the condenser extending through the bottom of the housing. The waste and clean drums are then placed side by side and the “black box’ placed over them with the inlet and outlet conduits extending through openings in the top walls or covers of the respective drums. This provides an easily managed and portable unit which is particularly well adapted to smaller operations.

FIG. 14 illustrates yet a further embodiment wherein the outlet 23 from the cooling system feeds a multi-position valve V, which in turn feeds a plurality of conduits 25₁₋ₙ. This is particularly useful where the contaminated solvent feed has “n” solvent fractions which are desired to be collected separately. Thus, each conduit 25₁₋ₙ would feed condensate to a respective one of n clean drums 11. The heating cycle is commenced by heating the distillation vessel to a temperature sufficient to boil the lowest fraction. At that time, valve V is positioned to feed only conduit 25₁. Condensed solvent from this fraction is collected in solvent collection drum 11₁. When distillation of the lowest fraction is complete, the temperature is raised to boil the next fraction and, at the same time, valve V is positioned to feed only conduit 25₁, thus allowing the next solvent fraction to be collected in drum 11₂. The process is continued for each of the solvent fractions up to the n^{th} fraction, at which time valve V is positioned to feed only conduit 25ₙ, thus allowing this solvent fraction to be collected in drum 11ₙ.

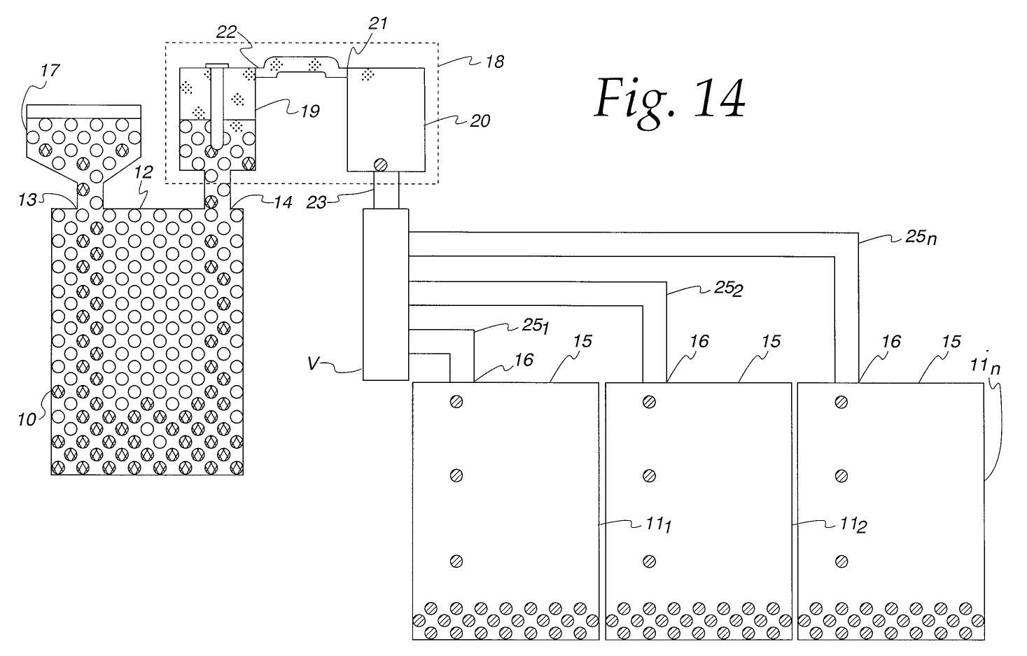

FIG. 15 shows a further embodiment of the invention, wherein the cover or top wall 12 of the drum 10 has an inlet 13 and an outlet 14. A heating means 100 extends downwardly into the drum 10. The upper region of the drum adjacent the heating means 100 defines a distillation zone and the lower region defines a waste collection zone. To prevent solvent vapours from the distillation zone within the drum 10 escaping through the inlet 13 of the drum when the distillation is proceeding, and to force the vapours to exit the outlet 14, a shut-off valve or cap 15 is provided at the inlet 13. As used solvent enters the drum through the inlet 13, heavy solvent waste will fall to the bottom of the drum in the form of sludge. When the heating means is energized, a distillation zone is created which is remote from the waste collection zone and is therefore substantially free of sludge. The heating means 100 may be in the form of an immersion heater having a jacketed heating element or other types of heating means may be employed such as microwave heating, for example.

Thus, it will be seen that the drum 10 has an upper distillation zone in the vicinity of the heating means and a lower waste collection zone and the drum acts as both the solvent supply drum and the solid waste collection drum, which eliminates the need for separate drums. Furthermore, there is no requirement for the use of a sludge collection bag, with all of the problems attendant upon the use of such bags, as described above, since the solid waste falls by gravity to the waste collection zone of the drum 10 and away from the distillation zone surrounding the heating means 100. Recycling efficiency is maximized, since the waste solvent in the distillation zone is already free of most heavy contaminants which have dropped to the bottom of the drum, and which therefore cannot impede heat transfer from the heating means 100. Thus, when dealing with heavy solids or sticky waste, there is no need of costly scrapers or other means of sludge removal from the walls of the drum or from around the heating means.

In the embodiment of FIG. 16, a funnel 17 is placed at the inlet 13 to the waste drum and the shut-off valve 15 is located between the funnel 17 and the inlet. A clean drum 11 for clean solvent is provided and the recycler includes a cooling system, such as a condenser 20. An inlet 21 to the condenser communicates with the outlet 14 of the drum and an outlet 23 of the condenser is located over an inlet 16 to the clean drum 11. If desired, the condenser 20 may be omitted and the solvent vapour allowed to condense in the conduit between the outlet 14 of the waste drum and the inlet 16 of the clean drum.

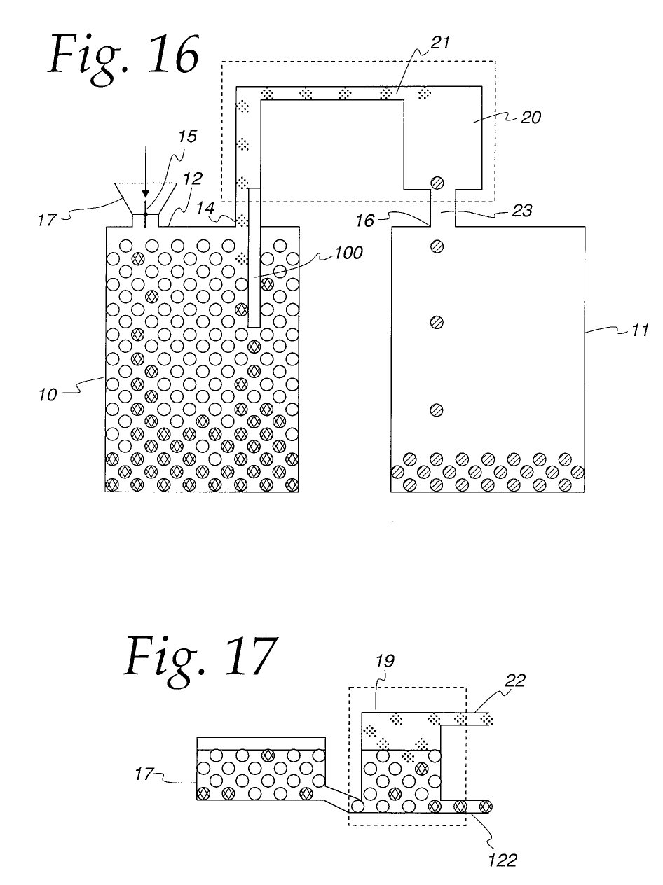

In the embodiment of FIG. 17, the funnel 17 feeds in to bottom of the distillation vessel 19 and a waste exit 122 is also provided at the bottom. Clean solvent vapour exits through outlet 22.

The embodiment of FIG. 18 is similar to FIG. 7, except that the heating means is in the form of a heating jacket, which heats the distillation zone from the bottom.

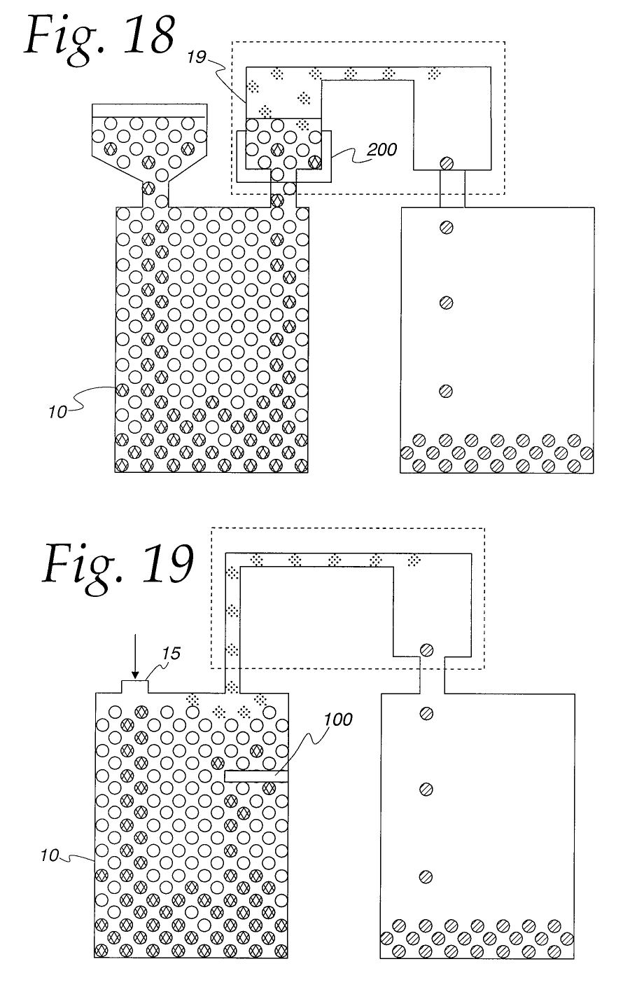

The embodiment of FIG. 19 is similar to FIG. 15, except that the heating element extends inwardly from the drum wall and therefore heats the distillation zone from beneath.

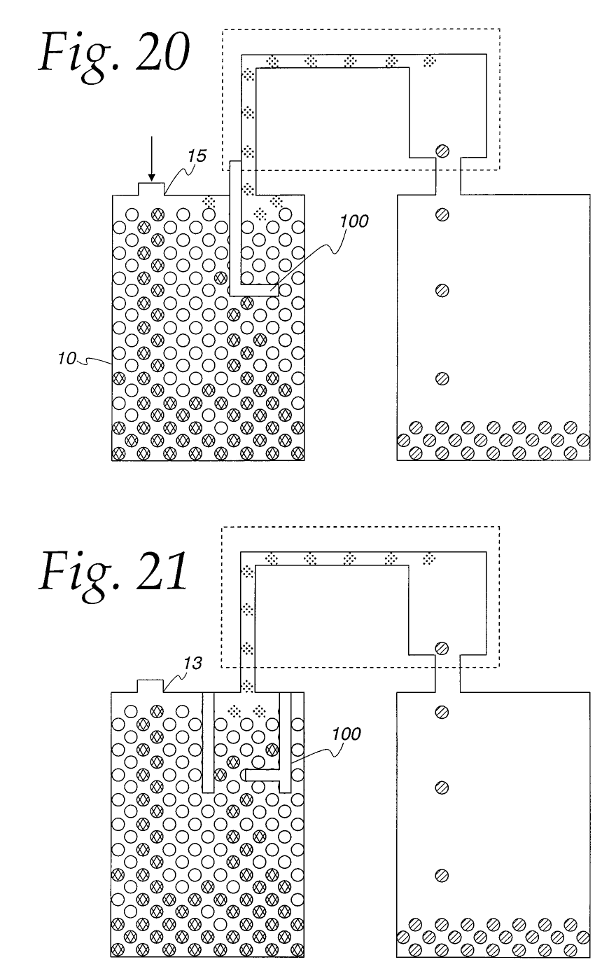

The embodiment of FIG. 20 is similar to FIG. 19, except that the heating element extends inwardly from a support extending downwardly from the drum cover and again heats the distillation zone from beneath.

The embodiment of FIG. 21 is similar to FIG. 2, except that the heating element extends inwardly from the shroud 300 and again heats the distillation zone from beneath.

Thus, the recycler of the present invention is able to be filled from the bottom. Its maximum level and volume to recycle may be controlled by the maximum level and volume above the bottom level of the recycling zone of an attached used solvent container and/or an attached funnel or filling system. The used solvent container may or may not be used as the contaminant collection container, which may or may not be removable.

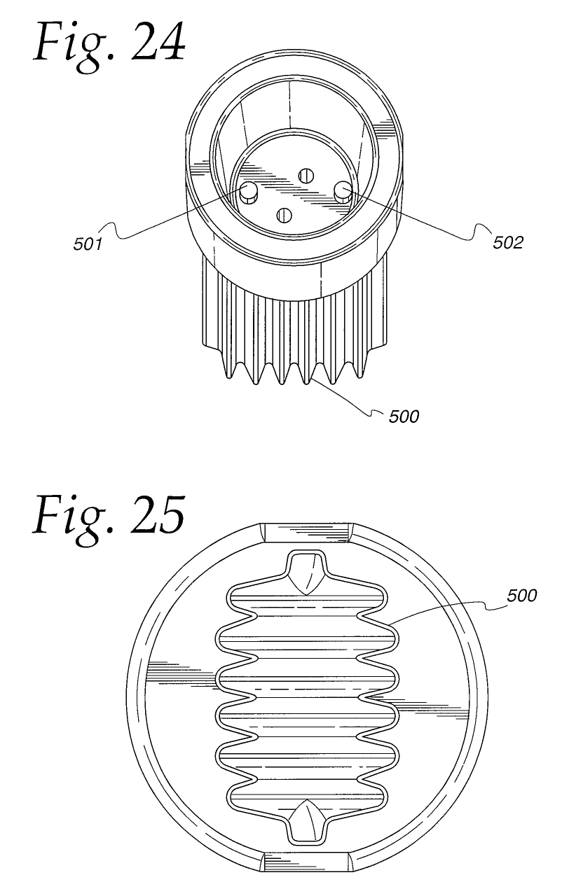

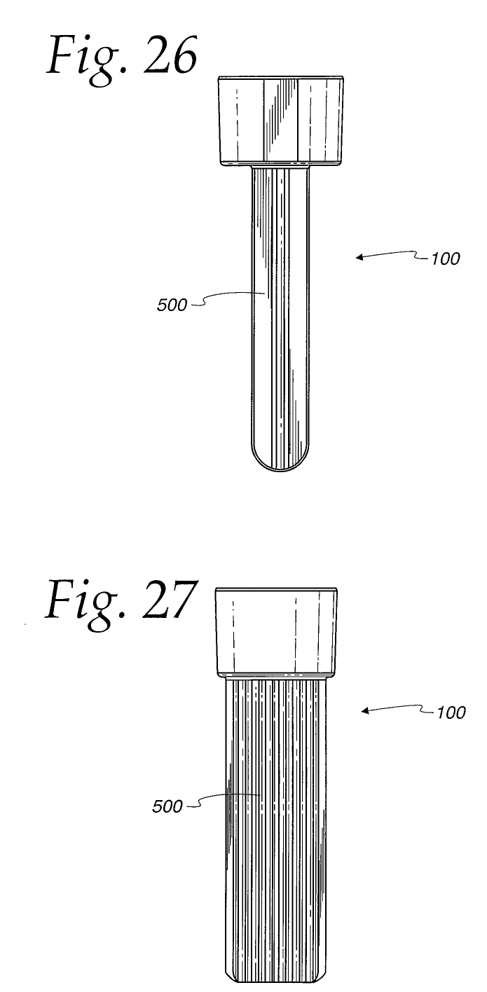

FIGS. 22-25 show a finned casing for the immersion heater 100, which is particularly suited for use in distillation of spent solvents having relatively non-sticky waste residue. The finned exchanger does not work as well with solvents containing sticky residue (such as paint) since the residue can cake on the fins 500. However, for many solvents the finned exchanger works very well and is advantageous because it increases the surface area of the heating means and consequently the volume of solvent in contact therewith to maximize the operating efficiency of the unit. FIGS. 22 and 23 are perspective views, and FIG. 24 is a top view showing the contacts 501 and 502 for the heating element (not shown) within the casing. FIG. 25 is a bottom view. FIGS. 26 and 27 are alternative designs of finned casings.

1. In a solvent recycling system, a distillation vessel having an upper distillation zone and a lower waste collection zone and means whereby the distillation zone is fed with solvent from below said distillation zone, so that solvent waste falls into said waste collection zone before solvent enters said distillation zone.

2. In a solvent recycling system, a distillation vessel having an upper distillation zone and a lower waste collection zone, a solvent feed inlet, a solvent vapour outlet and a heating means, whereby solvent enters the vessel from above through said solvent feed inlet and solvent waste falls into said waste collection zone before distillation is commenced, and, alternatively, a shut-off means or filling tube extending below distillation zone associated with said inlet to prevent solvent vapours exiting said vessel through said inlet during distillation.
